(19) United States
(12) Patent Application Publication
(10) Pub. No.: US 2024/0291026 A1
(43) Pub. Date: Aug. 29, 2024

(54) BATTERY

(71) Applicant: Panasonic Intellectual Property Management Co., Ltd., Osaka (JP)

(72) Inventors: Yumi MIYAMOTO, Osaka (JP); Yoshimasa NAKAMA, Osaka (JP)

(21) Appl. No.: 18/486,002

(22) Filed: Oct. 12, 2023

Related U.S. Application Data
(63) Continuation of application No. PCT/JP2022/001203, filed on Jan. 14, 2022.

(30) Foreign Application Priority Data
Apr. 20, 2021 (JP) 2021-071448

(51) Int. Cl. H01M 10/0562; H01M 4/02; H01M 4/505; H01M 4/62; H01M 10/0525; H01M 10/0585

(52) U.S. Cl. CPC H01M 10/0562; H01M 4/505; H01M 4/62; H01M 10/0525; H01M 10/0585; H01M 2004/028; H01M 2300/008

(57) ABSTRACT

The present disclosure includes: a positive electrode; a negative electrode; and an electrolyte layer disposed between the positive electrode and the negative electrode. The positive electrode includes a positive electrode active material. The positive electrode active material includes an oxide consisting of Li, Ni, Mn, and O. The electrolyte layer includes Li, Ti, M1, and F. The M1 is at least one selected from the group consisting of Ca, Mg, Al, Y, and Zr.

This application is a continuation of PCT/JP2022/001203 filed on Jan. 14, 2022, which claims foreign priority of Japanese Patent Application No. 2021-071448 filed on Apr. 20, 2021, the entire contents of both of which are incorporated herein by reference.

### BACKGROUND OF THE INVENTION

### 1. Field of the Invention

The present disclosure relates to a battery.

### 2. Description of Related Art

JP 2011-129312 A discloses an all-solid-state battery in which a sulfide solid electrolyte is used. JP 2008-277170 A discloses LiBF₄ as a fluoride solid electrolyte material.

### SUMMARY OF THE INVENTION

The present disclosure provides a technique for enhancing the charge and discharge capacity of the battery.

The present disclosure provides a battery including:
a positive electrode;
a negative electrode; and
an electrolyte layer disposed between the positive electrode and the negative electrode, wherein
the positive electrode includes a positive electrode active material,
the positive electrode active material includes an oxide consisting of Li, Ni, Mn, and O,
the electrolyte layer includes Li, Ti, M1, and F, and
the M1 is at least one selected from the group consisting of Ca, Mg, Al, Y, and Zr.

According to the technique of the present disclosure, it is possible to enhance the charge and discharge capacity of the battery.

### BRIEF DESCRIPTION OF THE DRAWINGS

FIG. 1 is a view showing a solid electrolyte according to Embodiment 1.

FIG. 2 is a cross-sectional view schematically showing the configuration of a battery according to Embodiment 2.

FIG. 3 is a cross-sectional view schematically showing the configuration of a battery according to Embodiment 3.

### DETAILED DESCRIPTION

### Findings on which the Present Disclosure is Based

Lithium nickel manganese oxide is expected as a positive electrode active material that can achieve a high operating voltage. On the other hand, halide solid electrolytes are promising as electrolytes for batteries because of exhibiting an excellent lithium-ion conductivity. It is conceivable that a combination of these materials can achieve a battery having a high operating voltage and a high output.

However, studies by the present inventors have found that, during charge of a battery, a halide solid electrolyte may decompose due to an oxidation reaction thus to significantly increase the internal resistance of the battery. Here, the oxidation reaction refers to a side reaction that occurs in addition to a normal charge reaction in which lithium and electrons are extracted from the positive electrode active material. In the side reaction, electrons are extracted even from the halide solid electrolyte in contact with the positive electrode active material. It is considered that this oxidation reaction forms, between the positive electrode active material and the halide solid electrolyte, an oxidative decomposition layer having a poor lithium-ion conductivity and serving as a high interfacial resistance in an electrode reaction of the positive electrode. As a result, a sufficient charge and discharge capacity cannot be obtained.

The problem with electrolyte decomposition becomes apparent particularly in the case where lithium nickel manganese oxide is used as the positive electrode active material. Therefore, to enhance the charge and discharge capacity of a battery in which lithium nickel manganese oxide is used, it is necessary to suppress an increase in internal resistance by suppressing formation of an oxidative decomposition layer due to a halide solid electrolyte.

On the basis of the above findings, the present inventors have arrived at the following battery of the present disclosure.

### Overview of One Aspect According to the Present Disclosure

A battery according to a first aspect of the present disclosure includes:
a positive electrode;
a negative electrode; and
an electrolyte layer disposed between the positive electrode and the negative electrode, wherein
the positive electrode includes a positive electrode active material,
the positive electrode active material includes an oxide consisting of Li, Ni, Mn, and O,
the electrolyte layer includes Li, Ti, M1, and F, and
the M1 is at least one selected from the group consisting of Ca, Mg, Al, Y, and Zr.

That is, owing to including F, the electrolyte included in the electrolyte layer has a high oxidation resistance. The electrolyte is less prone to be oxidatively decomposed, and accordingly a decomposition product of the electrolyte is less prone to be generated at the interface between the positive electrode and the electrolyte layer. This suppresses an increase in the internal resistance of the battery. As a result, the charge and discharge capacity of the battery is enhanced as compared with the case where an electrolyte having a poor oxidation resistance is used.

In a second aspect of the present disclosure, for example, in the battery according to the first aspect, the M1 may be Al. Al is inexpensive and is suitable as an element for enhancing the ionic conductivity of the electrolyte included in the electrolyte layer.

In a third aspect of the present disclosure, for example, in the battery according to the first or second aspect, the oxide may be lithium nickel manganese oxide. Lithium nickel manganese oxide is suitable for enhancing the operating voltage of the battery.

In a fourth aspect of the present disclosure, for example, in the battery according to any one of the first to third aspects, the oxide may have composition represented by LiNiₓMn₍₂₋ₓ₎O₄ where x may satisfy 0<x<2. The oxide represented by this chemical formula is a material obtained by substituting a portion of Mn in LiMn₂O₄ having a spinel structure with Ni, and is suitable for enhancing the operating voltage of the battery.

In a fifth aspect of the present disclosure, for example, in the battery according to any one of the first to fourth aspects, the oxide may have composition represented by LiNi_{0.5}Mn_{1.5}O₄. The oxide represented by this chemical formula is a material obtained by substituting a portion of Mn in LiMn₂O₄ having a spinel structure with Ni, and is suitable for enhancing the operating voltage of the battery.

In a sixth aspect of the present disclosure, for example, in the battery according to any one of the first to fifth aspects, the positive electrode further may include a positive electrode electrolyte, the positive electrode electrolyte may include Li, Ti, M2, and F, and the M2 may be at least one selected from the group consisting of Ca, Mg, Al, Y, and Zr. In the case where Li, Ti, M2, and F are included in the positive electrode electrolyte, the same effect as the effect obtained in the electrolyte included in the electrolyte layer is obtained in the positive electrode electrolyte.

In a seventh aspect of the present disclosure, for example, in the battery according to the sixth aspect, the positive electrode electrolyte may have the same composition as composition of an electrolyte included in the electrolyte layer. According to such a configuration, the effect described for the electrolyte included in the electrolyte layer is obtained in the entire positive electrode.

In an eighth aspect of the present disclosure, for example, in the battery according to any one of the first to seventh aspects, the electrolyte layer may include a first electrolyte layer and a second electrolyte layer, and the second electrolyte layer may be positioned between the first electrolyte layer and the negative electrode. According to such a configuration, it is possible to use an electrolyte having a high oxidation resistance as the material of the first electrolyte layer, and use an electrolyte having a high reduction resistance as the material of the second electrolyte layer.

In a ninth aspect of the present disclosure, for example, in the battery according to the eighth aspect, the first electrolyte layer may include Li, Ti, M1, and F, and the second electrolyte layer may include a sulfide solid electrolyte. The electrolyte including Li, Ti, M1, and F is excellent in oxidation resistance, and is accordingly suitable as the material of the first electrolyte layer. The sulfide solid electrolyte is excellent in reduction resistance, and is accordingly suitable as the material of the second electrolyte layer.

Embodiments of the present disclosure will be described below with reference to the drawings. First, a solid electrolyte that can be used in the battery of the present disclosure will be described, and then the battery of the present disclosure will be described.

### Embodiment 1

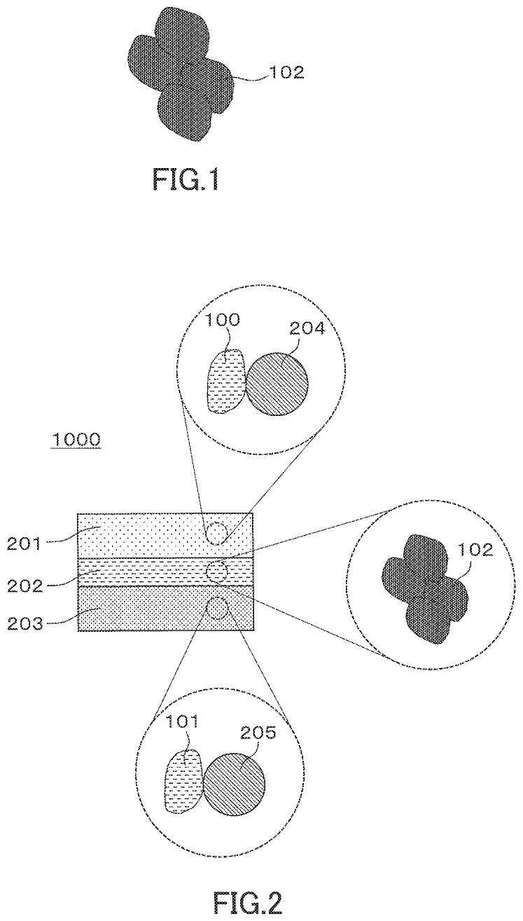

FIG. 1 shows a solid electrolyte 102 according to Embodiment 1. The solid electrolyte 102 includes Li, Ti, M1, and F. M1 is at least one selected from the group consisting of Ca, Mg, Al, Y, and Zr. As used herein, the solid electrolyte 102 is hereinafter referred to also as a “first solid electrolyte”.

Owing to including F, the solid electrolyte 102 has a high oxidation resistance. This is because F has a high oxidation-reduction potential. On the other hand, since F has a high electronegativity, the bond between F and Li is relatively strong. For this reason, a solid electrolyte including Li and F usually tends to have a low lithium-ion conductivity. For example, LiBF₄ disclosed in JP 2008-277170 A has a low ionic conductivity of 6.67×10⁻⁹ S/cm. In contrast with this, the solid electrolyte 102 according to the present embodiment includes Ti and M1 in addition to Li and F. Accordingly, an ionic conductivity of, for example, 1×10⁻⁸ S/cm or more can be achieved.

M1 is typically Al. Al is inexpensive and is suitable as an element for enhancing the ionic conductivity of the solid electrolyte 102.

The solid electrolyte 102 should desirably be free of sulfur. A solid electrolyte that is free of sulfur generates no hydrogen sulfide when exposed to the atmosphere, and is accordingly excellent in safety. The sulfide solid electrolyte disclosed in JP 2011-129312 A may generate hydrogen sulfide when exposed to the atmosphere.

To enhance the ionic conductivity, the solid electrolyte 102 may include an anion other than F. The anion other than F is at least one selected from the group consisting of Cl, Br, I, O, and Se.

The solid electrolyte 102 may consist substantially of Li, Ti, M1, and F. Here, the phrase “the solid electrolyte 102 consists substantially of Li, Ti, M1, and F” means that the molar ratio (i.e., mole fraction) of the sum of the amounts of substance of Li, Ti, M1, and F to the total of the amounts of substance of all the elements constituting the solid electrolyte 102 is 90% or more. In an example, the molar ratio may be 95% or more. The solid electrolyte 102 may consist of Li, Ti, M1, and F.

However, the solid electrolyte 102 may include an element that is inevitably incorporated. Examples of the element include hydrogen, oxygen, and nitrogen. Such an element is included in the raw material powders of the solid electrolyte 102, or is present in an atmosphere for manufacturing and storing the solid electrolyte 102.

To further enhance the ionic conductivity of the solid electrolyte 102, the ratio of the amount of substance of Li to the sum of the amounts of substance of Ti and M1 may be 1.7 or more and 4.2 or less.

The solid electrolyte 102 may have composition represented by the following Formula (1).

$$satisfies 0 < x < 1 and 0 < b \leq 1.5 . \qquad Formula ( 1 )$$

$${{Li}_{6 - ( 4 - x ) b} ( {Ti}_{1 - x} M {1}_{x} )}_{b} {F}_{6} \qquad Formula ( 1 )$$

To enhance the ionic conductivity of the solid electrolyte 102, Formula (1) may satisfy 0.1≤x≤0.9.

To enhance the ionic conductivity of the solid electrolyte 102, Formula (1) may satisfy 0.8≤b≤1.2.

In the case where the solid electrolyte 102 has a specific composition represented by Formula (1), the solid electrolyte 102 exhibits, for example, the following ionic conductivity. For example, in the case where M1 is Zr, the solid electrolyte 102 exhibits an ionic conductivity of about 2.1 μS/cm. In the case where M1 is Mg, the solid electrolyte 102 exhibits an ionic conductivity of about 2.1 μS/cm. In the case where M1 is Ca, the solid electrolyte 102 exhibits an ionic conductivity of about 0.02 μS/cm. In the case where M1 is Al, the solid electrolyte 102 exhibits an ionic conductivity of about 5.4 μS/cm. On the other hand, the oxidation resistance of the solid electrolyte 102 is derived mainly from F. In view of these facts, even replacing, with respect to M1, a specific element by a different element still enhances the charge and discharge capacity of the battery.

The solid electrolyte 102 may be crystalline, or may be amorphous.

The shape of the solid electrolyte 102 is not limited to any shape. The solid electrolyte 102 may be particulate. Examples of the particulate shape include an acicular shape, a spherical shape, and an ellipsoidal shape. The solid electrolyte 102 may be in the shape of pellet or a plate.

In the case where the solid electrolyte 102 is, for example, particulate, the particles of the solid electrolyte 102 may have a median diameter of 0.1 μm or more and 100 μm or less. The median diameter refers to the particle diameter at a cumulative volume equal to 50% in the volumetric particle size distribution. The volumetric particle size distribution is measured, for example, with a laser diffraction analyzer or an image analyzer.

The particles of the solid electrolyte 102 may have a median diameter of 0.5 μm or more and 10 μm or less. In this case, the solid electrolyte 102 has a higher ionic conductivity. Furthermore, in the case where the solid electrolyte 102 is mixed with a different material such as an active material, a well-dispersed state of the solid electrolyte 102 and the different material is achieved.

The solid electrolyte 102 is manufactured, for example, by the following method.

Raw material powders are prepared and mixed so as to obtain a target composition. The raw material powders are, for example, halides.

In an example, in the case where the target composition is Li_{2.7}Ti_{0.3}Al_{0.7}F₆, LiF, TiF₄, and AlF₃ are mixed in an approximate molar ratio of 2.7:0.3:0.7. The raw material powders may be mixed in a molar ratio adjusted in advance so as to cancel out a composition change that can occur in the synthesis process.

The raw material powders are mechanochemically reacted with each other in a mixer such as a planetary ball mill. That is, the raw material powders are reacted with each other by mechanochemical milling. Thus, a reaction product is obtained. The reaction product may be fired in a vacuum or in an inert atmosphere. Alternatively, the mixture of the raw material powders may be fired in a vacuum or in an inert atmosphere to obtain a reaction product. The firing is performed, for example, at 100° C. or more and 300° C. or less for 1 hour or more. To suppress a composition change during the firing, the raw material powders may be fired in a closed vessel such as a quartz tube.

By the above method, the solid electrolyte 102 is obtained.

### Embodiment 2

FIG. 2 is a cross-sectional view schematically showing the configuration of a battery 1000 according to Embodiment 2. The battery 1000 includes a positive electrode 201, an electrolyte layer 202, and a negative electrode 203. The electrolyte layer 202 is disposed between the positive electrode 201 and the negative electrode 203.

### (Electrolyte Layer 202)

The electrolyte layer 202 is in contact with the positive electrode 201 and the negative electrode 203. The electrolyte layer 202 includes the solid electrolyte 102 described in Embodiment 1. Therefore, the advantageous effect described in Embodiment 1 is obtained in the electrolyte layer 202. That is, owing to including F, the solid electrolyte 102 has a high oxidation resistance. The solid electrolyte 102 is less prone to be oxidatively decomposed, and accordingly a decomposition product of the solid electrolyte 102 is less prone to be generated at the interface between the positive electrode 201 and the electrolyte layer 202. This suppresses an increase in the internal resistance of the battery 1000. As a result, the charge and discharge capacity of the battery 1000 is enhanced as compared with the case where a solid electrolyte having a poor oxidation resistance is used. This effect is obtained to the maximum in the case where the positive electrode 201 includes lithium nickel manganese oxide.

The electrolyte layer 202 may consist substantially of the solid electrolyte 102, or may include a different solid electrolyte having a different composition from the composition of the solid electrolyte 102. The solid electrolyte 102 may be the main component of the electrolyte layer 202. The phrase “the electrolyte layer 202 consists substantially of the solid electrolyte 102” means that materials other than the solid electrolyte 102 are not intentionally added except for inevitable impurities.

As used herein, the “main component” refers to a component whose content is the highest on a mass ratio basis.

Examples of the different solid electrolyte include Li₂MgX₄, Li₂FeX₄, Li(Al, Ga, In)X₄, Li₃(Al, Ga, In)X₆, and LiI. X is at least one selected from the group consisting of F, Cl, Br, and I. One or a mixture of two or more selected from these can be used as the different solid electrolyte. As used herein, the different solid electrolyte is referred to also as a “second solid electrolyte”.

As used herein, when an element in a chemical formula is expressed as “(Al, Ga, In)” or the like, this expression indicates at least one element selected from the group of elements in parentheses. That is, “(Al, Ga, In)” is synonymous with “at least one selected from the group consisting of Al, Ga, and In”. The same applies to other elements.

In the case where not only the solid electrolyte 102, which is the first solid electrolyte, but also the second solid electrolyte is included in the electrolyte layer 202, the first solid electrolyte and the second solid electrolyte may be uniformly dispersed in the electrolyte layer 202. As described later, a layer made of the first solid electrolyte and a layer made of the second solid electrolyte may be laminated in the lamination direction of the battery 1000.

To enhance the energy density and the output of the battery 1000, the electrolyte layer 202 may have a thickness of 1 μm or more and 1000 μm or less.

### (Positive Electrode 201)

The positive electrode 201 includes a positive electrode active material 204 and a positive electrode electrolyte 100.

The positive electrode active material 204 includes a material capable of occluding and releasing metal ions such as lithium ions. In the present embodiment, the positive electrode active material 204 includes an oxide consisting of Li, Ni, Mn, and O. In other words, the positive electrode active material 204 includes lithium nickel manganese oxide. Lithium nickel manganese oxide is a material suitable for enhancing the operating voltage of the battery 1000.

The oxide consisting of Li, Ni, Mn, and O has composition represented, for example, by LiNiₓMn₍₂₋ₓ₎O₄. The symbol x satisfies 0<x<2. The symbol x may satisfy 0<x<0.6. The oxide typically has composition represented by LiNi_{0.5}Mn_{1.5}O₄. The oxides represented by these chemical formulas are each a material obtained by substituting a portion of Mn in LiMn₂O₄ having a spinel structure with Ni, and is suitable for enhancing the operating voltage of the battery 1000. The oxide consisting of Li, Ni, Mn, and O can have a spinel structure as well. The “oxide consisting of Li, Ni, Mn, and O” means that elements other than Li, Ni, Mn, and O are not intentionally added except for inevitable impurities.

The positive electrode active material 204 may include a known positive electrode active material other than lithium nickel manganese oxide. Lithium nickel manganese oxide may be the main component of the positive electrode active material 204.

The positive electrode electrolyte 100 includes Li, Ti, M2, and F. M2 is at least one selected from the group consisting of Ca, Mg, Al, Y, and Zr. The positive electrode electrolyte 100 can be a solid electrolyte. In the case where Li, Ti, M2, and F are included in the positive electrode electrolyte 100, the same effect as the effect obtained in the solid electrolyte 102 is obtained in the positive electrode electrolyte 100.

The positive electrode electrolyte 100 may have the same composition as the composition of the electrolyte included in the electrolyte layer 202. That is, the positive electrode electrolyte 100 may have the same composition as the composition of the solid electrolyte 102. In this case, the effect described for the solid electrolyte 102 is obtained in the entire positive electrode 201. Of course, the positive electrode electrolyte 100 may have a different composition from the composition of the solid electrolyte 102.

The positive electrode 201 may include only the positive electrode electrolyte 100 as the electrolyte, or may include a different electrolyte having a different composition from the composition of the positive electrode electrolyte 100. The positive electrode electrolyte 100 may be the main component of the electrolyte included in the positive electrode 201.

The positive electrode active material 204 is, for example, particulate. The positive electrode electrolyte 100 is, for example, particulate.

The particles of the positive electrode active material 204 may have a median diameter of 0.1 μm or more and 100 μm or less. In the case where the particles of the positive electrode active material 204 have a median diameter of 0.1 μm or more, a well-dispersed state of the particles of the positive electrode active material 204 and the particles of the positive electrode electrolyte 100 is achieved in the positive electrode 201. Consequently, the charge and discharge characteristics of the battery 1000 are enhanced. In the case where the particles of the positive electrode active material 204 have a median diameter of 100 μm or less, the diffusion rate of lithium inside the particles of the positive electrode active material 204 is enhanced. Consequently, the battery 1000 can operate at a high output.

The particles of the positive electrode active material 204 may have a larger median diameter than the particles of the positive electrode electrolyte 100 have. In this case, a well-dispersed state of the particles of the positive electrode active material 204 and the particles of the positive electrode electrolyte 100 is achieved in the positive electrode 201.

To enhance the energy density and the output of the battery 1000, the ratio of the volume of the positive electrode active material 204 to the sum of the volume of the positive electrode active material 204 and the volume of the positive electrode electrolyte 100 in the positive electrode 201 may be 0.30 or more and 0.95 or less.

At least a portion of the surface of the positive electrode active material 204 may be coated with a coating layer. The coating layer can be formed on the surface of the positive electrode active material 204, for example, prior to the mixing of the positive electrode active material 204 with the conductive additive and the binder. Examples of the coating material included in the coating layer include a sulfide solid electrolyte, an oxide solid electrolyte, and a halide solid electrolyte. In the case where the positive electrode electrolyte 100 includes a sulfide solid electrolyte, the coating material may include the first solid electrolyte described in Embodiment 1 in order to suppress oxidative decomposition of the sulfide solid electrolyte. In the case where the positive electrode electrolyte 100 includes the first solid electrolyte described in Embodiment 1, the coating material may include an oxide solid electrolyte in order to suppress oxidative decomposition of the first solid electrolyte. The oxide solid electrolyte that may be used is lithium niobate, which is excellent in stability at a high potential. By suppressing oxidative decomposition of the solid electrolyte, it is possible to suppress an increase in the overvoltage of the battery.

To enhance the energy density and the output of the battery 1000, the positive electrode 201 may have a thickness of 10 μm or more and 500 μm or less.

### (Negative Electrode 203)

The negative electrode 203 includes a negative electrode active material 205 and a negative electrode electrolyte 101.

The negative electrode active material 205 includes a material capable of occluding and releasing metal ions such as lithium ions. Examples of the negative electrode active material 205 include a metal material, a carbon material, an oxide, a nitride, a tin compound, and a silicon compound. The metal material may be a metal simple substance, or may be an alloy. Examples of the metal material include lithium metal and a lithium alloy. Examples of the carbon material include natural graphite, coke, partially graphitized carbon, a carbon fiber, spherical carbon, artificial graphite, and amorphous carbon. From the viewpoint of capacity density, preferred examples of the negative electrode active material include silicon (i.e., Si), tin (i.e., Sn), a silicon compound, and a tin compound. One or two or more selected from these materials can be used as the negative electrode active material 205.

Examples of the negative electrode electrolyte 101 include a sulfide solid electrolyte, an oxide solid electrolyte, and a halide solid electrolyte.

The negative electrode electrolyte 101 may have the same composition as the composition of the electrolyte included in the electrolyte layer 202. That is, the negative electrode electrolyte 101 may have the same composition as the composition of the solid electrolyte 102. Of course, the negative electrode electrolyte 101 may have a different composition from the composition of the solid electrolyte 102.

The negative electrode 203 may include only the negative electrode electrolyte 101 as the electrolyte, or may include a different electrolyte having a different composition from the composition of the negative electrode electrolyte 101. The negative electrode electrolyte 101 may be the main component of the electrolyte included in the negative electrode 203.

The negative electrode active material 205 may be selected in view of the reduction resistance of the negative electrode electrolyte 101. For example, in the case where the negative electrode 203 includes the first solid electrolyte described in Embodiment 1, the negative electrode active material 205 may be a material capable of occluding and releasing lithium ions at 0.27 V or more relative to lithium. Examples of such a negative electrode active material include titanium oxide, indium metal, and a lithium alloy. Examples of the titanium oxide include Li₄Ti₅O₁₂, LiTi₂O₄, and TiO₂. By using these negative electrode active materials as the negative electrode active material 205, it is possible to suppress reductive decomposition of the first solid electrolyte included in the negative electrode 203. As a result, the charge and discharge capacity of the battery 1000 is enhanced.

The negative electrode active material 205 is, for example, particulate. The negative electrode electrolyte 101 is, for example, particulate.

The particles of the negative electrode active material 205 may have a median diameter of 0.1 μm or more and 100 μm or less. In the case where the particles of the negative electrode active material 205 have a median diameter of 0.1 μm or more, a well-dispersed state of the particles of the negative electrode active material 205 and the particles of the negative electrode electrolyte 101 is achieved in the negative electrode 203. Consequently, the charge and discharge characteristics of the battery 1000 are enhanced. In the case where the particles of the negative electrode active material 205 have a median diameter of 100 μm or less, the diffusion rate of lithium inside the particles of the negative electrode active material 205 is enhanced. Consequently, the battery 1000 can operate at a high output.

The particles of the negative electrode active material 205 may have a larger median diameter than the particles of the negative electrode electrolyte 101 have. In this case, a well-dispersed state of the particles of the negative electrode active material 205 and the particles of the negative electrode electrolyte 101 is achieved in the negative electrode 203.

To enhance the energy density and the output of the battery 1000, the ratio of the volume of the negative electrode active material 205 to the sum of the volume of the negative electrode active material 205 and the volume of the negative electrode electrolyte 101 in the negative electrode 203 may be 0.30 or more and 0.95 or less. To enhance the energy density and the output of the battery 1000, the negative electrode 203 may have a thickness of 10 μm or more and 500 μm or less.

### Other Configurations

To enhance the ionic conductivity, chemical stability, and electrochemical stability, at least one selected from the group consisting of the positive electrode 201, the electrolyte layer 202, and the negative electrode 203 may include the second solid electrolyte.

The second solid electrolyte may be a sulfide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

The negative electrode electrolyte 101 may include a sulfide solid electrolyte. By coating the negative electrode active material 205 with the sulfide solid electrolyte, which is electrochemically stable, it is possible to prevent contact of the solid electrolyte 102 included in the electrolyte layer 202 with the negative electrode active material 205. This suppresses reductive decomposition of the solid electrolyte 102 included in the electrolyte layer 202. As a result, an increase in the internal resistance of the battery 1000 is suppressed.

The second solid electrolyte may be an oxide solid electrolyte.

Examples of the oxide solid electrolyte include the following materials:
(i) NASICON solid electrolytes such as LiTi₂(PO₄)₃ and element-substituted substances thereof;
(ii) perovskite solid electrolytes such as (LaLi)TiO₃;
(iii) LISICON solid electrolytes such as Li₁₄ZnGe₄O₁₆, Li₄SiO₄, and LiGeO₄ and element-substituted substances thereof;
(iv) garnet solid electrolytes such as Li₇La₃Zr₂O₁₂ and element-substituted substances thereof; and
(v) Li₃PO₄ and N-substituted substances thereof.

As described above, the second solid electrolyte may be a halide solid electrolyte.

Other examples of the halide solid electrolyte include a compound represented by LiₐMe_{b}Y_{c}X₆. Here, a+mb+3c=6 and c>0 are satisfied. Me is at least one selected from the group consisting of metalloid elements and metal elements except Li and Y. The symbol m represents the valence of Me. The “metalloid elements” refer to B, Si, Ge, As, Sb, and Te. The “metal elements” refer to all the elements included in Groups 1 to 12 of the periodic table (except hydrogen) and all the elements included in Groups 13 to 16 of the periodic table (except B, Si, Ge, As, Sb, Te, C, N, P, O, S, and Se).

To enhance the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb. The halide solid electrolyte may be Li₃YCl₆ or Li₃YBr₆.

The second solid electrolyte may be a polymer solid electrolyte. The polymer solid electrolyte can be a compound of a polymer compound and a lithium salt. The polymer compound may have an ethylene oxide structure. The polymer compound having the ethylene oxide structure can include a large amount of the lithium salt. Accordingly, it is possible to further enhance the ionic conductivity. Examples of the lithium salt include LiPF₆, LiBF₄, LiSbF₆, LiAsF₆, LiSO₃CF₃, LIN(SO₂F)₂, LIN(SO₂CF₃)₂, LIN(SO₂C₂F₅)₂, LIN(SO₂CF₃)(SO₂C₄F₉), and LiC(SO₂CF₃)₃. These lithium salts may be used alone, or may be used in combination.

To facilitate transfer of lithium ions and thus to enhance the output characteristics of the battery, at least one selected from the group consisting of the positive electrode 201, the electrolyte layer 202, and the negative electrode 203 may include a nonaqueous electrolyte solution, a gel electrolyte, or an ionic liquid.

The nonaqueous electrolyte solution includes a nonaqueous solvent and a lithium salt dissolved in the nonaqueous solvent.

Examples of the nonaqueous solvent include a cyclic carbonate solvent, a linear carbonate solvent, a cyclic ether solvent, a linear ether solvent, a cyclic ester solvent, a linear ester solvent, and a fluorinated solvent. Examples of the cyclic carbonate solvent include ethylene carbonate, propylene carbonate, and butylene carbonate. Examples of the linear carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the linear ether solvent include 1,2-dimethoxyethane and 1,2-diethoxyethane. Examples of the cyclic ester solvent include γ-butyrolactone. Examples of the linear ester solvent include methyl acetate.

Examples of the fluorinated solvent include fluoroethylene carbonate, methyl fluoropropionate, fluorobenzene, fluoroethyl methyl carbonate, and fluorodimethylene carbonate. One nonaqueous solvent selected from these may be used alone. Alternatively, a combination of two or more nonaqueous solvents selected from these may be used.

Examples of the lithium salt include LiPF₆, LiBF₄, LiSbF₆, LiAsF₆, LiSO₃CF₃, LIN(SO₂CF₃)₂, LIN(SO₂C₂F₅)₂, LIN(SO₂CF₃)(SO₂C₄F₉), and LiC(SO₂CF₃)₃. One lithium salt selected from these may be used alone. Alternatively, a mixture of two or more lithium salts selected from these may be used. The lithium salt has a concentration, for example, in a range of 0.5 mol/L to 2 mol/L.

The gel electrolyte that can be used is a polymer material impregnated with a nonaqueous electrolyte solution. Examples of the polymer material include polyethylene oxide, polyacrylonitrile, polyvinylidene fluoride, polymethyl methacrylate, and a polymer having an ethylene oxide bond.

Examples of a cation included in the ionic liquid include: (i) aliphatic linear quaternary salts such as tetraalkylammoniums and tetraalkylphosphoniums; (ii) aliphatic cyclic ammoniums such as pyrrolidiniums, morpholiniums, imidazoliniums, tetrahydropyrimidiniums, piperaziniums, and piperidiniums; and (iii) nitrogen-containing heterocyclic aromatic cations such as pyridiniums and imidazoliums.

Examples of an anion included in the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may include a lithium salt.

At least one selected from the group consisting of the positive electrode 201, the electrolyte layer 202, and the negative electrode 203 may include a binder in order to enhance the adhesion between the particles.

Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. A copolymer can also be used as the binder. Such a binder can be a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from these materials may be used as the binder.

To lower the electronic resistance, at least one selected from the group consisting of the positive electrode 201 and the negative electrode 203 may include a conductive additive.

Examples of the conductive additive include: (i) graphite such as natural graphite and artificial graphite; (ii) carbon black such as acetylene black and ketjen black; (iii) conductive fibers such as a carbon fiber and a metal fiber; (iv) fluorinated carbon; (v) metal powders such as an aluminum powder; (vi) conductive whiskers such as a zinc oxide whisker and a potassium titanate whisker; (vii) a conductive metal oxide such as titanium oxide; and (viii) conductive polymer compounds such as polyaniline compound, polypyrrole compound, and polythiophene compound. The conductive additive in (i) or (ii) above may be used for a decrease in cost.

The battery 1000 may be an all-solid-state battery, or may be a battery in which a liquid electrolyte or a gel electrolyte is partially used. The battery 1000 may be a primary battery, or may be a secondary battery.

The battery 1000 is of a coin type, a cylindrical type, a prismatic type, a sheet type, a button type, a flat type, or a laminate type.

The battery 1000 can be manufactured, for example, by preparing a material for forming a positive electrode, a material for forming an electrolyte layer, and a material for forming a negative electrode, and producing by a known method a laminate in which the positive electrode, the electrolyte layer, and the negative electrode are disposed in this order.

### Embodiment 3

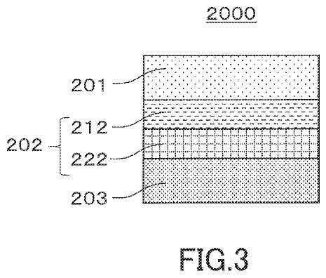

FIG. 3 is a cross-sectional view schematically showing the configuration of a battery 2000 according to Embodiment 3. The battery 2000 has the same configuration as the configuration of the battery 1000 of Embodiment 2 except that the electrolyte layer 202 is composed of a plurality of layers.

The electrolyte layer 202 includes a first electrolyte layer 212 and a second electrolyte layer 222. The first electrolyte layer 212 is positioned between the positive electrode 201 and the second electrolyte layer 222. The second electrolyte layer 222 is positioned between the first electrolyte layer 212 and the negative electrode 203. According to such a configuration, it is possible to use an electrolyte having a high oxidation resistance as the material of the first electrolyte layer 212, and use an electrolyte having a high reduction resistance as the material of the second electrolyte layer 222. The second electrolyte layer 222 is separated from the positive electrode 201 by the first electrolyte layer 212. Consequently, oxidative decomposition of the electrolyte included in the second electrolyte layer 222 can be suppressed. The first electrolyte layer 212 is separated from the negative electrode 203 by the second electrolyte layer 222. Consequently, reductive decomposition of the electrolyte included in the first electrolyte layer 212 can be suppressed.

The first electrolyte layer 212 is in contact with the positive electrode 201. The second electrolyte layer 222 is in contact with the negative electrode 203. The first electrolyte layer 212 is in contact with the second electrolyte layer 222. The electrolyte layer 202 may have a different layer disposed between the first electrolyte layer 212 and the second electrolyte layer 222.

The solid electrolyte included in the second electrolyte layer 222 may have a lower reduction potential than the solid electrolyte included in the first electrolyte layer 212 has. In this case, it is possible to avoid reduction of the solid electrolyte included in the first electrolyte layer 212. As a result, the charge and discharge efficiency of the battery 2000 is enhanced.

For example, in the case where the first electrolyte layer 212 includes the first solid electrolyte described in Embodiment 1, the second electrolyte layer 222 may include a sulfide solid electrolyte in order to suppress reductive decomposition of the first solid electrolyte. In other words, the first electrolyte layer 212 includes Li, Ti, M1, and F. The first solid electrolyte is excellent in oxidation resistance, and is accordingly suitable as the material of the first electrolyte layer 212. The sulfide solid electrolyte is excellent in reduction resistance, and is accordingly suitable as the material of the second electrolyte layer 222. By using the respective materials suitable for the first electrolyte layer 212 and the second electrolyte layer 222, decomposition of the electrolyte in the electrolyte layer 202 can be effectively suppressed. As a result, the charge and discharge efficiency of the battery 2000 is enhanced.

### EXAMPLES

The present disclosure will be described in more detail below with reference to an example and a comparative example.

### Example 1

### (Production of First Solid Electrolyte)

In an argon atmosphere, raw material powders of LiF, TiF₄, and AlF₃ were weighed in a molar ratio of LiF:TiF₄:AlF₃=2.7:0.3:0.7. Subsequently, these raw material powders were milled with a planetary ball mill (Type P-7 manufactured by Fritsch GmbH) under the conditions at 500 rpm for 12 hours thus to obtain a powder of Li_{2.7}Ti_{0.3}Al_{0.7}F₆ as the first solid electrolyte.

### [Production of Positive Electrode Material]

LiNi_{0.5}Mn_{1.5}O₄, Li_{2.7}Ti_{0.3}Al_{0.7}F₆, and VGCF (manufactured by SHOWA DENKO K. K.) as the conductive additive were weighed in a mass ratio of 72.8:26.2:1.0. Subsequently, these materials were mixed in a mortar. Thus, a positive electrode material of Example 1 was prepared. “VGCF” is the registered trademark of SHOWA DENKO K. K.

### Comparative Example 1

### [Production of Positive Electrode Material]

LiNi_{0.5}Mn_{1.5}O₄, Li₃YBr₂Cl₄, and VGCF as the conductive additive were weighed in a mass ratio of 72.8:26.2:1.0. Subsequently, these materials were mixed in a mortar. Thus, a positive electrode material of Comparative Example 1 was prepared.

### [Production of Battery]

Batteries using the respective positive electrode materials of Example 1 and Comparative Example 1 were produced by the following steps.

First, 80 mg of a powder of Li₆PS₅Cl was put into an insulating outer cylinder, and pressure-molding was performed at a pressure of 2 MPa. Next, 20 mg of the powder of the first solid electrolyte was put, and pressure-molding was performed at a pressure of 2 MPa. Furthermore, 9.8 mg of the positive electrode material was put, and pressure-molding was performed at a pressure of 720 MPa. Thus, a laminate consisting of the positive electrode and the electrolyte layer was obtained.

Next, a metal Li foil was laminated on the laminate so that the electrolyte layer was positioned between the metal Li foil as the negative electrode and the positive electrode. The metal Li foil had a thickness of 200 μm. The laminate was pressure-molded at a pressure of 2 MPa thus to produce a laminate consisting of the positive electrode, the electrolyte layer, and the negative electrode.

Next, stainless steel current collectors were placed on the top and the bottom of the laminate. Current collector leads were attached to the current collectors.

Finally, the insulating outer cylinder was sealed with an insulating ferrule so that the inside of the insulating outer cylinder was blocked from the outside air atmosphere. Through these steps, the batteries of Example 1 and Comparative Example 1 were obtained.

### [Charge Test]

The batteries of Example 1 and Comparative Example 1 were subjected to a charge test under the following conditions.

First, the battery was placed in a thermostatic chamber set at 85° C.

Next, constant-current charge was performed to 4.6 V (vs. Li/Li⁺) at a current value of 42 μA equivalent to 0.05 C rate (20-hour rate) relative to the theoretical capacity of the battery. Subsequently, constant-current charge and constant-voltage charge were repeated in increments of 0.05 V to an end-of-charge voltage of 5.0 V (vs. Li/Li⁺). The current value at the end of the constant-voltage charge was set to 8.4 μA equivalent to 0.01 C rate. The total charge capacity in the series of charge processes was measured as the initial charge capacity.

Next, constant-current discharge was performed to 4.6 V (vs. Li/Li⁺), and then constant-current discharge and constant-voltage discharge were repeated in increments of 0.05 V to an end-of-discharge voltage of 3.5 V (vs. Li/Li⁺). The current value at the end of the constant-voltage discharge was set to 8.4 μA equivalent to 0.01 C rate. The total discharge capacity in the series of discharge processes was measured as the initial discharge capacity.

The results are shown in Table 1. The characteristics of the solid electrolytes and the batteries according to Example 1 and Comparative Example 1 are shown in Table 1.

TABLE 1

| | | Initial charge | Initial discharge |
|---|---|---|---|
| | Solid electrolyte | capacity (mAh/g) | capacity (mAh/g) |
| Example 1 | Li_{2.7}Ti_{0.3}Al_{0.7}F₆ | 142 | 123 |
| Comparative | Li₃YBr₂Cl₄ | 13 | 0 |
| Example 1 | | | |

The battery of Example 1 exhibited an initial charge capacity of 142 mAh/g that is close to the theoretical capacity of LiNi_{0.5}Mn_{1.5}O₄ (147 mAh/g), and exhibited an initial discharge capacity of 123 mAh/g. In contrast with this, the battery of Comparative Example 1 exhibited an extremely low initial charge capacity, and exhibited an initial discharge capacity of almost zero.

### INDUSTRIAL APPLICABILITY

The technique of the present disclosure is useful for, for example, all-solid-state lithium-ion secondary batteries.

What is claimed is:

1. A battery comprising:
a positive electrode;
a negative electrode; and
an electrolyte layer disposed between the positive electrode and the negative electrode, wherein
the positive electrode comprises a positive electrode active material,
the positive electrode active material comprises an oxide consisting of Li, Ni, Mn, and O,
the electrolyte layer comprises Li, Ti, M1, and F, and
the M1 is at least one selected from the group consisting of Ca, Mg, Al, Y, and Zr.

2. The battery according to claim 1, wherein
the M1 is Al.

3. The battery according to claim 1, wherein
the oxide is lithium nickel manganese oxide.

4. The battery according to claim 1, wherein
the oxide has composition represented by LiNiₓMn₍₂₋ₓ₎O₄
where x satisfies 0<x<2.

5. The battery according to claim 1, wherein
the oxide has composition represented by LiNi_{0.5}Mn_{1.5}O₄.

6. The battery according to claim 1, wherein
the positive electrode further comprises a positive electrode electrolyte,
the positive electrode electrolyte comprises Li, Ti, M2, and F, and
the M2 is at least one selected from the group consisting of Ca, Mg, Al, Y, and Zr.

7. The battery according to claim 6, wherein
the positive electrode electrolyte has the same composition as composition of an electrolyte included in the electrolyte layer.

8. The battery according to claim 1, wherein
the electrolyte layer comprises a first electrolyte layer and a second electrolyte layer, and
the second electrolyte layer is positioned between the first electrolyte layer and the negative electrode.

9. The battery according to claim 8, wherein
the first electrolyte layer comprises Li, Ti, M1, and F, and
the second electrolyte layer comprises a sulfide solid electrolyte.
